(19) United States
(12) Patent Application Publication
(10) Pub. No.: US 2024/0070539 A1
(43) Pub. Date: Feb. 29, 2024

(54) LEARNING DEVICE

(71) Applicant: NEC Corporation, Tokyo (JP)

(72) Inventors: Junki Mori, Tokyo (JP); Isamu Teranishi, Tokyo (JP); Ryo Furukawa, Tokyo (JP)

(73) Assignee: NEC Corporation, Tokyo (JP)

(21) Appl. No.: 18/237,214

(22) Filed: Aug. 23, 2023

(30) Foreign Application Priority Data
Aug. 30, 2022 (JP) 2022-137349

(51) Int. Cl. G06N 20/00

(52) U.S. Cl. CPC G06N 20/00

(57) ABSTRACT

A learning device includes an acquisition unit that acquires a local model corresponding to a feature value held by the own device, a residual calculation unit that calculates a difference between an output of a vertical federated learning model having been learned previously and an output of the local model acquired by the acquisition unit, and an additional tree learning unit that learns an additional tree to be added to the local model acquired by the acquisition unit, on the basis of the result of calculation by the residual calculation unit and the feature value held by the own device.

### INCORPORATION BY REFERENCE

The present invention is based upon and claims the benefit of priority from Japanese patent application No. 2022-137349, filed on Aug. 30, 2022, the disclosure of which is incorporated herein in its entirety by reference.

### TECHNICAL FIELD

The present invention relates to a learning device, a learning method, and an inference device.

### BACKGROUND ART

As a machine learning model having high accuracy and small computation quantity with respect to tabular format data and the like, a Gradient Boosting Decision Tree (GBDT) has been known.

As a literature about GBDT, for example, Patent Literature 1 has been known. Patent Literature 1 describes a learning device for performing learning using gradient boosting. For example, a learning device includes a data storage unit that stores therein learning data and gradient information to learn a model; a learning unit that learns the model; an update unit that updates the gradient information; a sub-sampling unit that determines whether or not to use the learning data to learn the next model based on a sub-sampling rate; a first buffer unit for buffering the learning data and the gradient information, determined to be used, up to a predetermined capacity; and a second buffer unit for buffering the learning data and the gradient information, determined not to be used, up to a predetermined capacity. When buffering the learning data and the gradient information up to a predetermined capacity, the first buffer unit and the second buffer unit write to the data storage unit for each given block. According to Patent Literature 1, with the above-described configuration, it is possible to perform data sampling on a large amount of sample data in gradient boosting.
Patent Literature 1: JP 2021-015523 A
Non-Patent Literature 1: Ren et al., Improving Availability of Vertical Federated Learning, [Searched on Jul. 22, 2022], Internet <URL: https://dl.acm.org/doi/10.1145/3501817>

### SUMMARY

As one type of federated learning for performing training of a machine learning model through cooperation by a plurality of clients without direct handling of learning data, vertical federated learning has been known. In vertical federated learning, training is performed by using different feature values for the same sample in the case where respective clients have different feature values for the same sample.

In the case of performing such vertical federated learning on a decision tree such as a GBDT, for each node constituting the decision tree serving as a vertical federated learning model, any of the clients that perform vertical federated learning has a value such as a branch condition. As a result, cooperation between clients having a value of a corresponding node is required for inference, so that inference cannot be performed in the case where cooperation between the clients is difficult. Even in the case where cooperation is possible, it takes labor for inference. Moreover, as vertical federated learning that can be inferred independently, one described in Non-Patent Literature has been known. The art described in Non-Patent Literature 1 is directed to a parametric model such as a neural network or logistic regression, and is not suitable for a decision tree system. As described above, there is a problem that it is difficult to learn a model in which labor for inference can be suppressed with respect to a decision tree such as a GBDT, by vertical federated learning.

In view of the above, an exemplary object of the present invention is to provide a learning device, a learning method, a storage medium, and an inference device that solve the above-described problem.

In order to achieve such an object, a learning device according to one aspect of the present disclosure is configured to include
an acquisition unit that acquires a local model corresponding to a feature value held by the own device,
a residual calculation unit that calculates a difference between an output of a vertical federated learning model having been learned previously and an output of the local model acquired by the acquisition unit, and
an additional tree learning unit that learns an additional tree to be added to the local model acquired by the acquisition unit, on the basis of the result of calculation by the residual calculation unit and the feature value held by the own device.

Further, a learning method according to another aspect of the present disclosure is a method configured to include, by an information processing device,
acquiring a local model corresponding to a feature value held by the own device;
calculating a difference between an output of a vertical federated learning model having been learned previously and an output of the acquired local model; and
learning an additional tree to be added to the acquired local model on the basis of the result of the calculation and the feature value held by the own device.

Further, a storage medium according to another aspect of the present disclosure is a computer-readable medium storing thereon a program for causing an information processing device to execute processing to
acquire a local model corresponding to a feature value held by the own device;
calculate a difference between an output of a vertical federated learning model having been learned previously and an output of the acquired local model; and
learn an additional tree to be added to the acquired local model on the basis of the result of the calculation and the feature value held by the own device.

Further, an inference device according to another aspect of the present disclosure is configured to include
an inference unit that inputs a feature value that is an inference object to a local model to which an additional tree is added based on the result of calculating a difference between an output of a vertical federated learning model and an output of the local model and on the feature value held by the own device, the vertical federated learning model having been learned previously, the local model corresponding to a feature value held by the own device, and performs output corresponding to a result of the input.

With the configurations described above, the problem described above can be solved.

### BRIEF DESCRIPTION OF DRAWINGS

FIG. 1 illustrates the outline of a learning system according to a first example embodiment of the present disclosure;

FIG. 2 illustrates vertical federated learning;

FIG. 3 illustrates an exemplary configuration of a learning system;

FIG. 4 is a block diagram illustrating an exemplary configuration of a learning device.

FIG. 5 illustrates an example of a vertical federated learning model;

FIG. 6 is a block diagram illustrating an exemplary configuration of a client device;

FIG. 7 is a flowchart illustrating an exemplary operation of a learning device;

FIG. 8 illustrates an exemplary hardware configuration of a learning device according to a second example embodiment of the present disclosure;

FIG. 9 is a block diagram illustrating an exemplary configuration of a learning device; and

FIG. 10 is a block diagram illustrating an exemplary configuration of an inference device.

### EXAMPLE EMBODIMENTS

### First Example Embodiment

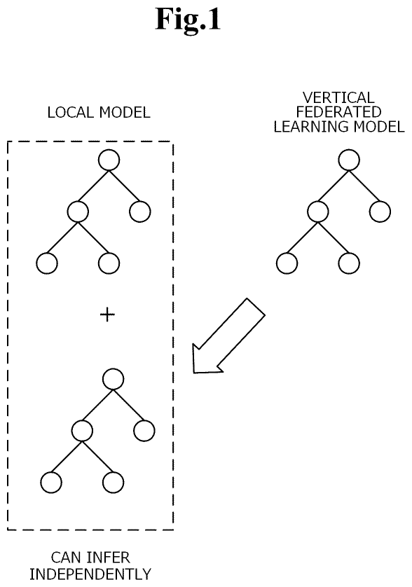

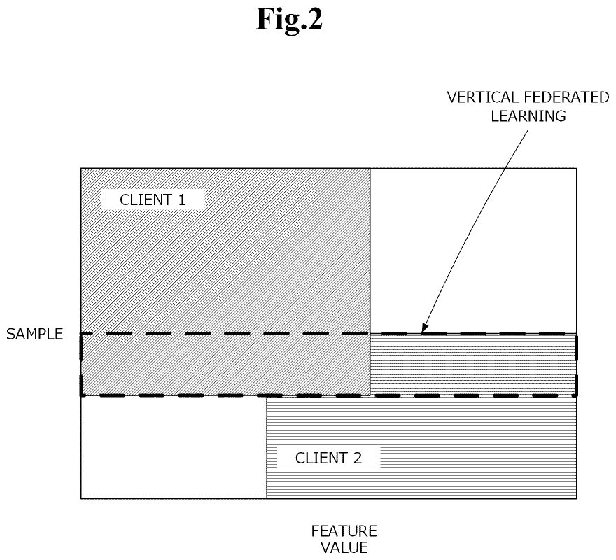

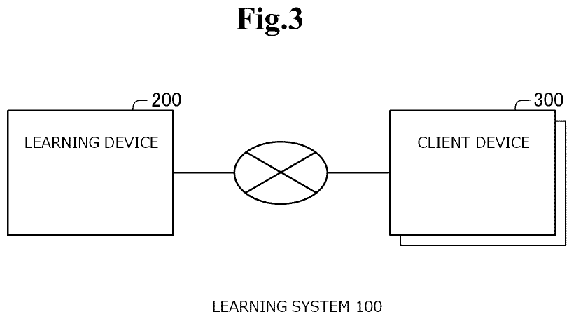

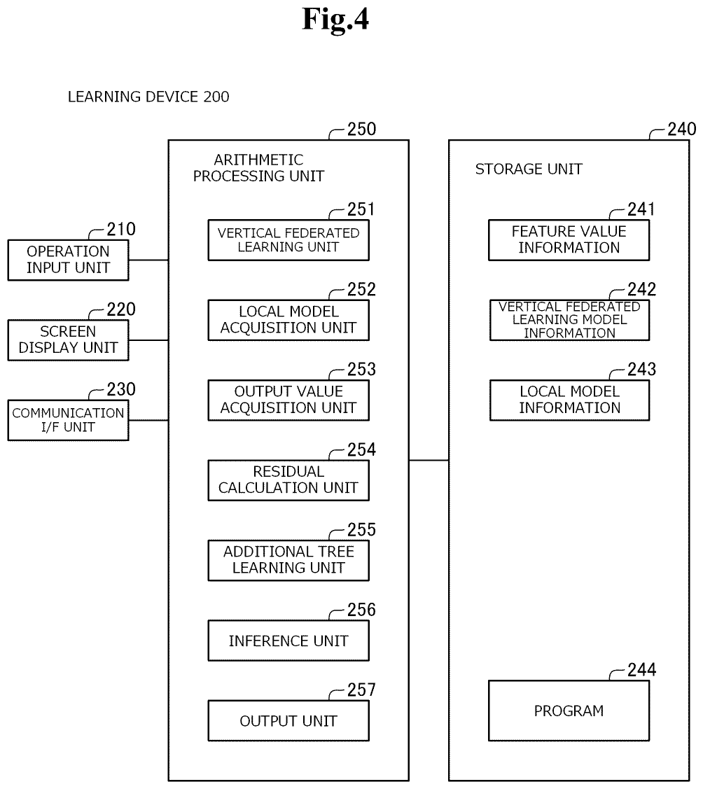

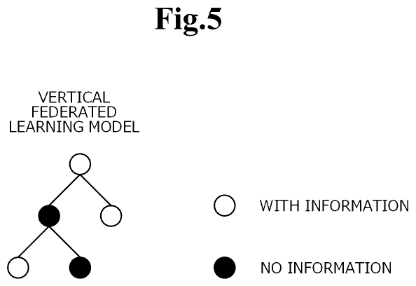

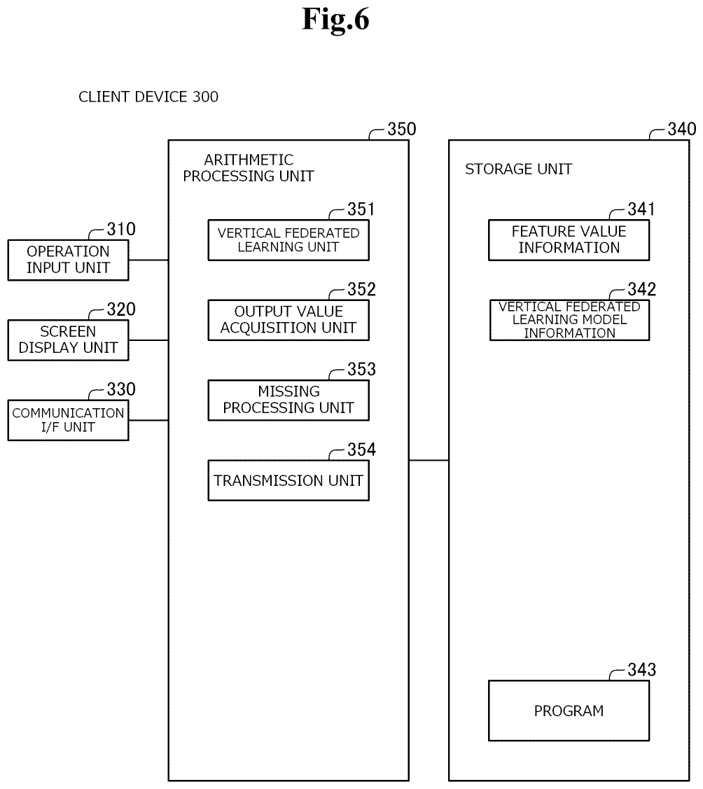

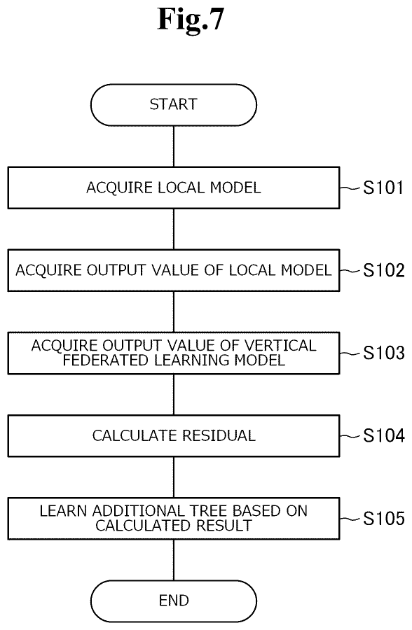

A first example embodiment of the present disclosure will be described with reference to FIGS. 1 to 7. FIG. 1 illustrates the outline of a learning system 100. FIG. 2 illustrates vertical federated learning. FIG. 3 illustrates an exemplary configuration of a learning system 100. FIG. 4 is a block diagram illustrating an exemplary configuration of a learning device 200. FIG. 5 illustrates an example of a vertical federated learning model. FIG. 6 is a block diagram illustrating an exemplary configuration of a client device 300. FIG. 7 is a flowchart illustrating an exemplary operation of the learning device 200.

A first example embodiment of the present disclosure describes a learning system 100 in which a plurality of information processing devices such as a learning device 200 and a client device 300 perform federated learning to learn a decision tree in corporation with each other. As illustrated in FIG. 1, the learning device 200 in the present embodiment acquires a vertical federated learning model having been learned in cooperation with other information processing devices such as the client device 300, and acquires a local model by a given means. Then, the learning device 200 learns a new additional tree so as to fill the gap between the vertical federated learning model and the local model. By learning an additional tree in addition to the local model as described above, at the time of inference, the learning device 200 can perform inference independently without a need to cooperate with other information processing devices.

In the present embodiment, as illustrated in FIG. 2, the case of performing vertical federated learning of the federated learning will be described as an example. Vertical federated learning is learning using different feature values for the same sample. For example, in the example of FIG. 2, a client 1 and a client 2 that are the learning device 200 and the client device 300 have different feature values for the same sample. For example, the vertical federated learning can be performed in the case where there are a plurality of information processing devices handling different feature values although samples such as customers are the same, such as the case where companies of different business categories have customers in the same region. In the case of performing vertical federated learning, values of nodes constituting the decision tree such as output values and branch conditions are held by information processing devices having feature values corresponding to the branch conditions and the like. This means that for the respective nodes constituting the decision tree that is a vertical federated learning model, the information processing devices each having a value such as a branch condition are different. As a result, in principle, it is necessary for the information processing devices that performed vertical federated learning to cooperate with each other even for inference. In the learning system 100 described in the present embodiment, as described above, a new additional tree is learned so as to fill the gap between the vertical federated learning model and the local model in the learning device 200 that desires to perform inference independently, among the information processing devices that perform learning in cooperation with each other. As a result, it is possible to perform inference independently by the learning device 200 while performing vertical federated learning.

Hereinafter, the configuration of the learning system 100 will be described in more detail. FIG. 3 illustrates an exemplary configuration of the learning system 100. Referring to FIG. 3, for example, the learning system 100 includes a plurality of client devices 300 and the learning device 200. As illustrated in FIG. 3, the client devices 300 and the learning device 200 are connected communicably with each other over a network or the like, for example. Note that the learning system 100 may include any number (two or more) of learning devices 200. The learning system 100 may include any number (two or more) of client devices 300.

The learning device 200 is an information processing device that learns a vertical federated learning model in cooperation with the client device 300. Moreover, the learning device 200 learns a new additional tree so as to fill the gap between the learned vertical federated learning model and the local model so as to be able to perform inference independently. FIG. 4 illustrates an exemplary configuration of the learning device 200. Referring to FIG. 4, the learning device 200 includes an operation input unit 210, a screen display unit 220, a communication interface (UF) unit 230, a storage unit 240, and an arithmetic processing unit 250, for example, as main constituent elements.

FIG. 4 illustrates the case of implementing the function of the learning device 200 using one information processing device, as an example. However, the learning device 200 may be implemented using a plurality of information processing devices such as implemented on the cloud, for example. For example, the learning device 200 may be configured of a learning device that learns models such as a vertical federated learning model and an additional tree, and an inference device that performs inference using the learned models. Moreover, the learning device 200 may not include part of the above-mentioned constituent elements such as not including the operation input unit 210 or the screen display unit 220, or may include a constituent element other than those described above.

The operation input unit 210 is configured of operation input devices such as a keyboard and a mouse. The operation input unit 210 detects operation by an operator who operates the learning device 200, and outputs it to the arithmetic processing unit 250.

The screen display unit 220 is a screen display device such as a liquid crystal display (LCD). The screen display unit 220 can display, on the screen, various types of information stored in the storage unit 240, in response to an instruction from the arithmetic processing unit 250.

The communication I/F unit 230 is configured of a data communication circuit or the like. The communication I/F unit 230 performs data communication with external devices such as the client devices 300 connected over a communication network.

The storage unit 240 is a storage device such as a hard disk drive (HDD), a solid state drive (SSD), or a memory. The storage unit 240 stores therein processing information and a program 244 required for various types of processing performed in the arithmetic processing unit 250. The program 244 is read and executed by the arithmetic processing unit 250 to thereby implement various processing units. The program 244 is read in advance from an external device or a storage medium via a data input/output function of the communication I/F unit 230 and the like, and is stored in the storage unit 240. The main information stored in the storage unit 240 includes, for example, feature value information 241, vertical federated learning model information 242, local model information 243, and the like.

The feature value information 241 includes a feature value that is learning data used for performing vertical federated learning. As described above, the feature value information 241 can be utilized for acquiring a local mode, acquiring output values of a vertical federated learning model and a local model, and the like. For example, the feature value information 241 may include a plurality of feature values for a plurality of samples such as table-format data. The feature value information 241 includes a feature value for a sample that can be used in the vertical federated learning and is shared with another information processing device such as the client device 300. The feature value information 241 may include a feature value of a sample not shared with another information processing device. The feature value information 241 is acquired previously by using a method of acquiring it from an external device via the communication IN unit 230 or inputting it using the operation input unit 210, and is stored in the storage unit 240.

The vertical federated learning model information 242 includes information about a vertical federated learning model generated as a result of vertical federated learning performed in cooperation with another information processing device such as the client device 300. For example, the vertical federated learning model information 242 may include an output value of a leaf node constituting the decision tree that is a vertical federated learning model, a value corresponding to a branch condition at an internal node such as a feature value and a threshold serving as a branch condition, and the like. For example, the vertical federated learning model information 242 is updated in response to vertical federated learning performed by a vertical federated learning unit 251, described below, in cooperation with another information processing device.

FIG. 5 illustrates an exemplary decision tree that is a vertical federated learning model. As illustrated in FIG. 5, when vertical federated learning is performed, an information processing device having information such as a value corresponding to the branch condition and an output value differs for each node constituting the decision tree. Therefore, in the vertical federated learning model information 242, only some values of nodes among the values of the nodes constituting the decision tree are included. For example, in the example shown in FIG. 5, while the vertical federated learning model information 242 includes the values of the nodes shown by while circles, the vertical federated learning model information 242 does not include the values of the nodes shown by black circles. Note that nodes whose values are included in the vertical federated learning model information 242 are not limited to those shown in FIG. 5.

The local model information 243 includes information about a model unique to the learning device 200. For example, the local model information 243 may include an output value of a leaf node constituting the decision tree that is a local model, a value corresponding to a branch condition at an internal node, and the like. The local model information 243 may also include information about an additional tree to be learned by an additional tree learning unit 255 described below. That is, the local model information 243 may include an output value of a leaf node constituting an additional tree, a value corresponding to a branch condition at an internal node, and the like. For example, the local model information 243 is updated corresponding to acquisition of a local model by a local model acquisition unit 252 described below, learning of an additional tree by the additional tree learning unit 255, or the like. A method of acquiring a local model will be described below.

The arithmetic processing unit 250 includes an arithmetic unit such as a central processing unit (CPU) and the peripheral circuits thereof. The arithmetic processing unit 250 reads, from the storage unit 240, and executes the program 244 to implement various processing units through cooperation between the hardware and the program 244. Main processing units to be implemented by the arithmetic processing unit 250 include, for example, a vertical federated learning unit 251, a local model acquisition unit 252, an output value acquisition unit 253, a residual calculation unit 254, an additional tree learning unit 255, an inference unit 256, an output unit 257, and the like.

Note that the arithmetic processing unit 250 may include a Graphic Processing Unit (GPU), a Digital Signal Processor (DSP), an Micro Processing Unit (MPU), an Floating point number Processing Unit (FPU), a Physics Processing Unit (PPU), a Tensor Processing Unit (TPU), a quantum processor, a microcontroller, or a combination thereof, instead of the CPU.

The vertical federated learning unit 251 learns a vertical federated learning model in cooperation with another information processing device such as the client device 300. The vertical federated learning unit 251 also stores the learning result in the storage unit 240 as the vertical federated learning model information 242. In the present embodiment, a specific method for vertical federated learning is not limited particularly. The vertical federated learning unit 251 may learn a vertical federated learning model by using a general method for vertical federated learning.

The local model acquisition unit 252 acquires a local model that is a model unique to the learning device 200 and corresponds to the feature value held by the own device. The local model acquisition unit 252 stores the acquired local model in the storage unit 240 as the local model information 243.

For example, the local model acquisition unit 252 can acquire the decision tree that is a local model by performing learning using the own feature value included in the feature value information 241. At that time, a feature value of a sample not shared with another information processing device may also be used for learning. The local model acquisition unit 252 may learn a decision tree that is a local model by using a typical method for learning a decision tree.

Moreover, the local model acquisition unit 252 may acquire a local model generated based on the vertical federated learning model learned by the vertical federated learning unit 251, instead of learning using a feature value included in the feature value information 241. For example, the local model acquisition unit 252 can acquire a local model generated by applying processing to handle a node whose value is not included in the vertical federated learning model information 242 as a missing value.

As an example, each client device 300 previously performs processing to handle a node in which a value such as a branch condition is held by the own device in the vertical federated learning model, as a missing value. The local model acquisition unit 252 can acquire a local model by acquiring the vertical federated learning model in which processing to handle as a missing value has been performed from each client device 300 and integrating the acquired models. In other words, on the basis of the model acquired from each client device 300, the local model acquisition unit 252 can acquire a local model corresponding to the feature value held by the learning device 200 by applying processing to handle a node whose value such as a branch condition is held by each client device 300, that is, node whose value is not held by the learning device 200, as a missing value.

Examples of processing to handle as a missing value include, for example, previously setting a branch direction, setting a branch condition corresponding to an average value of feature values, and the like. For example, for a node to be handled as a missing value, each client device 300 can set a branch direction previously such that branch is always made in a direction where the difference in the loss function is larger. Alternatively, each client device 300 can set the branch condition on the basis of an average value of the feature values of the own device or the like such that branch is made based on the average value of the feature values. Note that processing to handle as a missing value may be one other than that described above as an example. For example, a branch direction may be set such that branch is made in a predetermined direction such as a left direction, or a branch direction and a branch condition may be set by other known means.

Moreover, for a value of a node not included in the vertical federated learning model information 242, the local model acquisition unit 252 may acquire a local model by performing processing to handle the value of the node as a missing value, instead of performing processing to handle the node as a missing value by each client device 300. In that case, for example, the local model acquisition unit 252 may perform processing to handle the node as a missing value such that branch is made in a predetermined direction.

The local model acquisition unit 252 can acquire a local model by using any of the methods described above as examples. For example, by acquiring a local model through learning based on the feature value included in the feature value information 241, the local model acquisition unit 252 can also acquire a local model using a sample that is not overlapped. Alternatively, the local model acquisition unit 252 can acquire a local model succeeding the structure of a vertical federated learning model of high generalization property by acquiring a local model in which processing to handle as a missing value is performed on the vertical federated learning.

The output value acquisition unit 253 acquires an output when all feature values used as learning data when learning the vertical federated learning model are input to the vertical federated learning model. That is, the output value acquisition unit 253 acquires an output value when feature values held by the learning device 200 and the respective client devices 300 are input to the vertical federated learning model in cooperation with the respective client devices 300. For example, the output value acquisition unit 253 acquires output values when the respective feature values corresponding to a sample i (i=1 to N) are input, in cooperation with the respective client devices 300. Note that N may be an arbitrary value.

Moreover, the output value acquisition unit 253 acquires an output value when a feature value included in the feature value information 241 is input to the local model. Similarly, the output value acquisition unit 253 acquires an output value when the feature values corresponding to the sample i (i=1 to N) are input, from the local model.

In this way, the output value acquisition unit 253 can acquire an output value from the vertical federated learning model in cooperation with the respective client devices 300, and also acquire an output value from the local model.

The residual calculation unit 254 calculates the residual by calculating the difference between the output value from the vertical federated learning model and the output value from the local model, on the basis of the results acquired by the output value acquisition unit 253.

For example, the residual calculation unit 254 calculates the residual of the sample i (i=1 to N) by solving Expression 1.

{ᵢ^{global}−yᵢ^{local}}ᵢ₌₁^{N} [Expression 1]

y_{global} represents an output value from the vertical federated learning model. y_{local} represents an output value from the local model.

The additional tree learning unit 255 learns a new additional tree so as to fill the gap between the vertical federated learning model and the local model. For example, the additional tree learning unit 255 performs learning using the result of calculation by the residual calculation unit 254. The number of trees to be added can be set arbitrarily. The additional tree learning unit 255 stores the learned additional tree in the storage unit 240 as the local model information 243.

For example, the additional tree learning unit 255 adds an additional tree to the local model with a label in which the feature value of each sample in the feature value information 241 is an explanatory variable and the residual corresponding to each sample calculated by the residual calculation unit 254 is an objective variable. As an example, the additional tree learning unit 255 may learn an additional tree by using a general Gradient Boosting Decision Tree (GBDT) algorithm. For example, the additional tree learning unit 255 performs calculation using an expression such as Expression 2 to thereby be able to determine a branch condition at an internal node with which the difference L^{split} in the loss function before and after the branch becomes maximum.

$$[ Expression 2 ]$$

$${ℒ}_{split} = \frac{1}{2} [ \frac{{( {\sum }_{i ∈ {I}_{L}} {g}_{i} )}^{2}}{{\sum }_{i ∈ {I}_{L}} {h}_{i} + λ} + \frac{{( {\sum }_{i ∈ {I}_{R}} {g}_{i} )}^{2}}{{\sum }_{i ∈ {I}_{R}} {h}_{i} + λ} - \frac{{( {\sum }_{i ∈ I} {g}_{i} )}^{2}}{{\sum }_{i ∈ I} {h}_{i} + λ} ] - γ$$

Note that gᵢ and hᵢ represent numbers called gradient information. Further, I_{L} represents learning data that proceeds to a left-side node after the division, and I_{R} represents learning data that proceeds to a right-side node after the division. Further, I represents learning data present on the node before the division. As described above, in Expression 1, the difference in the loss function before and after the division is calculated.

In addition, the additional tree learning unit 255 can determine an output value of a leaf node by performing calculation using an expression such as Expression 3.

$$[ Expression 3 ]$$

$${w}_{j}^{*} = - \frac{{\sum }_{i ∈ {I}_{j}} {g}_{i}}{{\sum }_{i ∈ {I}_{j}} {h}_{i} + λ}$$

Note that gᵢ and hᵢ represent numbers called gradient information, as similar to Expression 1.

The inference unit 256 performs inference in response to an instruction from an external device or the like. As described above, the inference unit 256 described in the present embodiment can perform inference independently without any cooperation with another client device 300, by performing inference using a local model to which an additional tree is added. In other words, the inference unit 256 inputs a feature value that is an inference object acquired from an external device or the like to the local model to which an additional tree is added, whereby it can acquire an output corresponding to an input.

Note that the inference unit 256 may perform inference in cooperation with another information processing device such as the client device 300, as similar to the case of the conventional vertical federated learning. For example, the inference unit 256 may be configured to communicate with another information device such as the client device 300 or the like to check whether or not it is possible to be in cooperation with the other information processing device, and in response to the check result, determine whether or not to perform inference independently.

The output unit 257 displays an inference result by the inference unit 256 on the screen display unit 220, or transmits it to an external device via the communication I/F unit 230. In addition, the output unit 257 may also display information stored in the storage unit 240 or the like on the screen display unit 220, or transmit it to an external device via the communication I/F unit 230.

The exemplary configuration of the learning device 200 is as described above. Next, an exemplary configuration of the client device 300 will be described with reference to FIG. 6.

The client device 300 is an information processing device that learns a vertical federated learning model in cooperation with the learning device 200. For example, the client device 300 can include part of the configuration held by the learning device 200. FIG. 6 illustrates an exemplary configuration of the client device 300. Referring to FIG. 6, the client device 300 includes, for example, an operation input unit 310, a screen display unit 320, a communication I/F unit 330, a storage unit 340, and an arithmetic processing unit 350, as main constituent elements.

The client device 300 may be implemented using a plurality of information processing devices such as implemented on the cloud, as similar to the learning device 200. Moreover, the client device 300 may not include part of the above-mentioned constituent elements such as not including the operation input unit 310 or the screen display unit 320, or may include a constituent element other than those described above.

The configurations of the operation input unit 310, the screen display unit 320, and the communication OF unit 330 may be the same as those of the learning device 200. Therefore, the description thereof is omitted.

The storage unit 340 is a storage device such as an HDD, an SSD, or a memory. The storage unit 340 stores therein processing information and a program 343 required for various types of processing performed in the arithmetic processing unit 350. The program 343 is read and executed by the arithmetic processing unit 350 to thereby implement various processing units. The program 343 is read in advance from an external device or a storage medium via the data input/output function of the communication OF unit 330 or the like, and is stored in the storage unit 340. The main information stored in the storage unit 340 includes, for example, feature value information 341, vertical federated learning model information 342, and the like.

The feature value information 341 includes a feature value that is learning data used for performing vertical federated learning or the like. As described below, the feature value information 341 can be utilized for acquiring an output value of the vertical federated learning model and the like. For example, the feature value information 341 may include a plurality of feature values for a plurality of samples such as table-format data, as similar to the case of the feature value information 241. The feature value information 341 is acquired previously by using a method of acquiring it from an external device via the communication OF unit 330 or inputting it using the operation input unit 310, and is stored in the storage unit 340.

The vertical federated learning model information 342 includes information about a vertical federated learning model generated as a result of vertical federated learning performed in cooperation with other information processing devices such as the learning device 200 and another client device 300. For example, the vertical federated learning model information 342 may include an output value of a leaf node constituting the decision tree that is a vertical federated learning model, a value corresponding to a branch condition at an internal node such as a feature value and a threshold serving as a branch condition, and the like. As similar to the case of the vertical federated learning model information 242, in the vertical federated learning model information 342, only some values of nodes among the values of the nodes constituting the decision tree are included. For example, the vertical federated learning model information 342 is updated in response to vertical federated learning performed by a vertical federated learning unit 351 described below in cooperation with another information processing device.

The arithmetic processing unit 350 includes an arithmetic unit such as a CPU and its peripheral circuits. The arithmetic processing unit 350 reads, from the storage unit 340, and executes the program 343 to implement various processing units through cooperation between the hardware and the program 343. Main processing units to be implemented by the arithmetic processing unit 350 include, for example, the vertical federated learning unit 351, an output value acquisition unit 352, a missing processing unit 353, a transmission unit 354, and the like.

Note that the arithmetic processing unit 350 may have a GPU, an MPU, an FPU, a PPU, a TPU, a quantum processor, a microcontroller, or a combination thereof, instead of the CPU described above.

The vertical federated learning unit 351 learns a vertical federated learning model in cooperation with other information processing devices such as the learning device 200 and another client device 300. The vertical federated learning unit 351 also stores the learning result in the storage unit 340 as the vertical federated learning model information 342. In the present embodiment, a specific method for vertical federated learning is not limited particularly. The vertical federated learning unit 351 may learn a vertical federated learning model by using a general method for vertical federated learning.

The output value acquisition unit 352 acquires an output when all feature values used as learning data when learning the vertical federated learning model are input to the vertical federated learning model. That is, the output value acquisition unit 352 acquires an output value when the feature values held by the learning device 200 and each client device 300 are input to the vertical federated learning model in cooperation with the learning device 200 and another client device 300. For example, the output value acquisition unit 352 acquires an output value when the respective feature values corresponding to the sample i (i=1 to N) are input, in cooperation with the learning device 200 and another client device 300. Note that N may be an arbitrary value.

The missing processing unit 353 performs processing to handle a node in which a value such as a branch condition is held by the own device in the vertical federated learning model as a missing value. As described above, examples of processing to handle as a missing value by the missing processing unit 353 include, for example, previously setting a branch direction, setting a branch direction corresponding to an average value of feature values, and the like. The missing processing unit 353 may perform processing to handle a node in which a value is held by the own device as a missing value by using any of the methods illustrated above.

The transmission unit 354 transmits the vertical federated learning model in which the missing processing unit 353 performed processing to handle as a missing value, to the learning device 200. For example, the transmission unit 354 may transmit, to the learning device 200, information for identifying the corresponding node and a result of processing to handle as a missing value such as a branch direction in association with each other.

The exemplary configuration of the client device 300 is as described above. For example, the learning system 100 includes a plurality of information processing devices as described above. In other words, among the information processing devices in the learning system 100, an information processing device having a configuration for performing independent inference is the learning device 200, and an information processing device not having a configuration for performing independent inference is the client device 300.

Next, an exemplary operation of the learning device 200 at the time of additional tree learning will be described with reference to FIG. 7. FIG. 7 is a flowchart illustrating an exemplary operation of the learning device 200. For example, the learning device 200 has a vertical federated learning model by performing federated learning previously in cooperation with other client devices 300. With reference to FIG. 7, the local model acquisition unit 252 acquires a local model that is a model unique to the learning device 200 (step S101). For example, the local model acquisition unit 252 may acquire a local model by using either a method of acquiring a local model through learning based on the feature value included in the feature value information 241 or a method of acquiring a local model in which processing to handle as a missing value is performed on the vertical federated learning model.

The output value acquisition unit 253 acquires an output value when the feature value included in the feature value information 241 is input to the local model (step S102). For example, the output value acquisition unit 253 acquires an output value when the feature value corresponding to the sample i (i=1 to N) is input, from the local model.

Moreover, the output value acquisition unit 253 acquires outputs when all feature values used as learning data when learning the vertical federated learning model are input to the vertical federated learning model (step S103). That is, the output value acquisition unit 253 acquires output values when the feature values held by the learning device 200 and the respective client devices 300 are input to the vertical federated learning model in cooperation with the respective client devices 300. For example, the output value acquisition unit 253 acquires output values when respective feature values corresponding to the sample i (i=1 to N) are input, in cooperation with the respective client devices 300.

The learning device 200 may perform the processing of step S102 or the processing of step S103 first, or perform them in parallel.

The residual calculation unit 254 calculates the residual by calculating the difference between the output value from the vertical federated learning model and the output value from the local model, on the basis of the results acquired by the output value acquisition unit 253 (step S104). For example, the residual calculation unit 254 can calculate the residual by subtracting the output value of the local model from the output value of the vertical federated learning model.

The additional tree learning unit 255 learns a new additional tree so as to fill the gap between the vertical federated learning model and the local model (step S105). For example, the additional tree learning unit 255 adds an additional tree to the local model with a label in which the feature value of each sample in the feature value information 241 is an explanatory variable and the residual corresponding to each sample calculated by the residual calculation unit 254 is an objective variable. The additional tree learning unit 255 may learn an additional tree by using a general Gradient Boosting Decision Tree (GBDT) algorithm.

An exemplary operation of the learning device 200 for additional tree learning is as described above.

As described above, the learning device 200 includes the local model acquisition unit 252 and the additional tree learning unit 255. According to this configuration, the additional tree learning unit 255 can learn a new additional tree so as to fill the gap between the vertical federated learning model and the local model. As a result, at the time of inference, it is possible to perform inference using a local model to which an additional tree is added, and even in the case of performing vertical federated learning, it is possible to perform inference without any cooperation with another information processing device such as the client device 300. That is, according to the above-described configuration, the labor for inference can be reduced.

### Second Example Embodiment

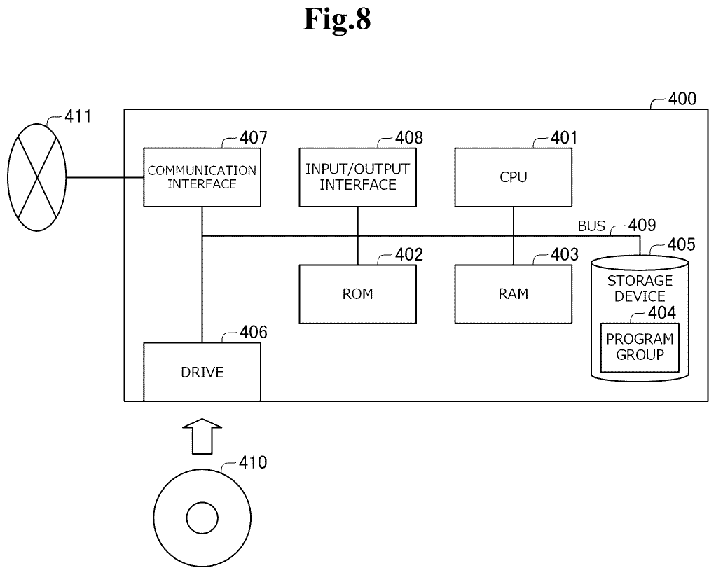

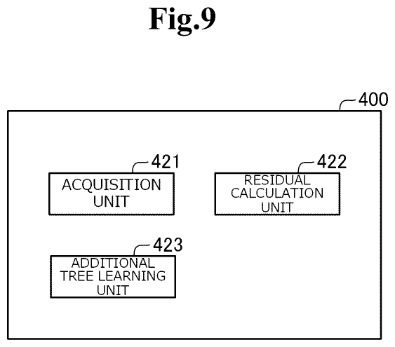

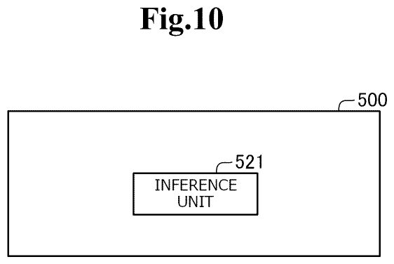

Next, a second example embodiment of the present disclosure will be described with reference to FIGS. 8 to 10. FIG. 8 is a diagram illustrating an exemplary hardware configuration of a learning device 400. FIG. 9 is a block diagram illustrating an exemplary configuration of the learning device 400. FIG. 10 is a block diagram illustrating an exemplary configuration of an inference device 500.

In the second embodiment of the present disclosure, exemplary configurations of the learning device 400 that is an information processing device that performs learning in cooperation with another information processing device, and the inference device 500 that performs inference independently by using the result of learning by the learning device 400, will be described. FIG. 8 illustrates an exemplary hardware configuration of the learning device 400. Referring to FIG. 8, the learning device 400 has a hardware configuration as described below, as an example.
Central Processing Unit (CPU) 401 (arithmetic device)
Read Only Memory (ROM) 402 (storage device)
Random Access Memory (RAM) 403 (storage device)
Program group 404 to be loaded to the RAM 403
Storage device 405 storing therein the program group 404
Drive 406 that performs reading and writing on a storage medium 410 outside the information processing device
Communication interface 407 connecting to a communication network 411 outside the information processing device
Input/output interface 408 for performing input/output of data
Bus 409 connecting the respective constituent elements

Note that the learning device 400 may use a GPU, an MPU, an FPU, a PPU, a TPU, a quantum processor, a microcontroller, or a combination thereof, instead of the CPU described above.

Moreover, the learning device 400 can realize functions as the acquisition unit 421, the residual calculation unit 422, and the additional tree learning unit 423 illustrated in FIG. 9 through acquisition and execution of the program group 404 by the CPU 401. Note that the program group 404 is stored in the storage device 405 or the ROM 402 in advance for example, and is loaded to the RAM 403 or the like by the CPU 401 as needed. Further, the program group 404 may be provided to the CPU 401 via the communication network 411, or may be stored on the storage medium 410 in advance and read out by the drive 406 and supplied to the CPU 401.

FIG. 8 illustrates an exemplary hardware configuration of the learning device 400. The hardware configuration of the learning device 400 is not limited to that described above. For example, the learning device 400 may be configured of part of the configuration described above, such as without the drive 406.

The acquisition unit 421 acquires a local model corresponding to a feature value held by the own device.

The residual calculation unit 422 calculates a difference between an output of a vertical federated learning model having been learned previously and an output of the local model acquired by the acquisition unit 421.

The additional tree learning unit 423 learns an additional tree to be added to the local model acquired by the acquisition unit 421, on the basis of the result of calculation by the residual calculation unit 422 and the feature value held by the own device.

As described above, the learning device 400 includes the acquisition unit 421, the residual calculation unit 422, and the additional tree learning unit 423. With this configuration, the additional tree learning unit 423 can learn the additional tree to be added to the local model acquired by the acquisition unit 421, on the basis of the result of calculation by the residual calculation unit 422 and the feature value held by the own device. As a result, it is possible to perform inference independently using the local model to which the additional tree is added. Therefore, the labor for inference can be reduced.

Note that the learning device 400 as described above can be realized by incorporation of a predetermined program in the information processing device such as the learning device 400. Specifically, a program that is another aspect of the present invention is a program for realizing, on an information processing device such as the learning device 400, processing to acquire a local model corresponding to a feature value held by the own device, calculate a difference between an output of a vertical federated learning model having been learned previously and an output of the acquired local model, and, on the basis of the calculation result and the feature value held by the own device, learn an additional tree added to the acquired local model.

Further, a learning method to be executed by an information processing device such as the learning device 400 is a method including, by an information processing device such as the learning device 400, acquiring a local model corresponding to a feature value held by the own device, calculating a difference between an output of a vertical federated learning model having been learned previously and an output of the acquired local model, and, on the basis of the calculation result and the feature value held by the own device, learning an additional tree to be added to the acquired local model.

An invention of a program, a computer-readable medium storing thereon a program, or a learning method, having the above-described configuration, also exhibits the same actions and effects as those of the learning device 400. Therefore, the above-described object of the present invention can also be achieved by such an invention.

Moreover, the inference device 500 using the learning result by the learning device 400 can realize the function as the inference unit 521 illustrated in FIG. 10 through acquisition and execution of the program group by the CPU or the like. Note that the hardware configuration of the inference device 500 may be similar to the configuration of the learning device 400 described with reference to FIG. 8.

The inference unit 521 inputs a feature value that is an inference object to a local model to which an additional tree is added based on the result of calculating a difference between an output of a vertical federated learning model having been learned and an output of the local model corresponding to the feature value held by the own device and also based on the feature value held by the own device, and performs output corresponding to the result of input.

As described above, the inference device 500 includes the inference unit 521. With this configuration, the inference unit 521 can perform inference independently although vertical federated learning has been performed. As a result, the labor for inference can be reduced.

Note that the inference device 500 as described above can be realized by incorporation of a predetermined program in an information processing device such as the inference device 500. Specifically, a program that is another aspect of the present invention is a program for realizing, on an information processing device such as the inference device 500, processing to input a feature value that is an inference object to the local model to which an additional tree is added based on the result of calculating a difference between an output of a vertical federated learning model having been learned and an output of the local model corresponding to a feature value held by the own device and also based on the feature value held by the own device, and performs output corresponding to the result of input.

Further, an inference method executed by an information processing device such as the inference device 500 is a method including inputting a feature value that is an inference object to a local model to which an additional tree is added based on the result of calculating a difference between an output of a vertical federated learning model having been learned and an output of the local model corresponding to the feature value held by the own device, and also based on the feature value held by the own device, and performing output corresponding to a result of the input.

An invention of a program, a computer-readable medium storing thereon a program, or an inference method, having the above-described configuration, also exhibits the same actions and effects as those of the inference device 500. Therefore, the above-described object of the present invention can also be achieved by such an invention.

### <Supplementary Notes>

The whole or part of the example embodiments disclosed above can be described as the following supplementary notes. Hereinafter, the outlines of the learning device and the like of the present invention will be described. However, the present invention is not limited to the configurations described below.

### (Supplementary Note 1)

A learning device comprising:
an acquisition unit that acquires a local model corresponding to a feature value held by the own device,
a residual calculation unit that calculates a difference between an output of a vertical federated learning model having been learned previously and an output of the local model acquired by the acquisition unit, and
an additional tree learning unit that learns an additional tree to be added to the local model acquired by the acquisition unit, on a basis of a result of calculation by the residual calculation unit and the feature value held by the own device.

### (Supplementary Note 2)

The learning device according to supplementary note 1, wherein
the acquisition unit acquires the local model by performing learning using the feature value held by the own device.

### (Supplementary Note 3)

The learning device according to supplementary note 1, wherein
the acquisition unit acquires, as the local model, a model in which processing to handle as a missing value is performed on a node corresponding to a device other than the own device, in a decision tree constituting the vertical federated learning model.

### (Supplementary Note 4)

The learning device according to supplementary note 3, wherein
the acquisition unit acquires, as the local model, a model in which processing to previously determine a branch direction at an object node is performed, as the processing to handle as a missing value.

### (Supplementary Note 5)

The learning device according to supplementary note 3, wherein
the acquisition unit acquires, in another learning device that is different from the own device, a model in which the processing to handle as a missing value is performed on a node corresponding to a feature value held by the other learning device, from the other learning device as the local model.

### (Supplementary Note 6)

The learning device according to supplementary note 1, wherein
the additional tree learning unit learns an additional tree to be added to the local model by performing learning using the difference calculated by the residual calculation unit as an objective variable and the feature value held by the own device as an explanatory variable.

### (Supplementary Note 7)

The learning device according to supplementary note 1, further comprising
an output acquisition unit that acquires an output of the vertical federated learning model in cooperation with each client device that created the vertical federated learning model.

### (Supplementary Note 8)

A learning method comprising, by an information processing device:
acquiring a local model corresponding to a feature value held by an own device;
calculating a difference between an output of a vertical federated learning model having been learned previously and an output of the acquired local model; and
learning an additional tree to be added to the acquired local model on a basis of a result of the calculation and the feature value held by the own device.

### (Supplementary Note 9)

A program for causing an information processing device to execute processing to
acquire a local model corresponding to a feature value held by the own device;
calculate a difference between an output of a vertical federated learning model having been learned previously and an output of the acquired local model; and
learn an additional tree to be added to the acquired local model on a basis of a result of the calculation and the feature value held by the own device.

### (Supplementary Note 10)

An inference device comprising
an inference unit that inputs a feature value that is an inference object to a local model to which an additional tree is added based on a result of calculating a difference between an output of a vertical federated learning model and an output of the local model and on the feature value held by the own device, the vertical federated learning model having been learned previously, the local model corresponding to a feature value held by an own device, and performs output corresponding to a result of the input.

While the present invention has been described with reference to the example embodiments described above, the present invention is not limited to the above-described embodiments. The form and details of the present invention can be changed within the scope of the present invention in various manners that can be understood by those skilled in the art.

### REFERENCE SIGNS LIST

100 learning system
200 learning device
210 operation input unit
220 screen display unit
230 communication IN unit
240 storage unit
241 feature value information
242 vertical federated learning model information
243 local model information
244 program
250 arithmetic processing unit
251 vertical federated learning unit
252 local model acquisition unit
253 output value acquisition unit
254 residual calculation unit
255 additional tree learning unit
256 inference unit
257 output unit
300 client device
310 operation input unit
320 screen display unit
330 communication IN unit
340 storage unit
341 feature value information
342 vertical federated learning model information
343 program
350 arithmetic processing unit
351 vertical federated learning unit
352 output value acquisition unit
353 missing processing unit
354 transmission unit
400 learning device
401 CPU
402 ROM
403 RAM
404 program group
405 storage device
406 drive
407 communication interface
408 input/output interface
409 bus
410 storage medium
411 communication network
421 acquisition unit
422 residual calculation unit
423 additional tree learning unit
500 inference device
521 inference unit

1. A learning device comprising:
at least one memory configured to store instructions; and
at least one processor configured to execute instructions to:
acquire a local model corresponding to a feature value held by an own device;
calculate a difference between an output of a vertical federated learning model having been learned previously and an output of the acquired local model; and
learn an additional tree to be added to the acquired local model on a basis of a result of the calculation and the feature value held by the own device.

2. The learning device according to claim 1, wherein the at least one processor is configured to execute the instructions to
acquire the local model by performing learning using the feature value held by the own device.

3. The learning device according to claim 1, wherein the at least one processor is configured to execute the instructions to
acquire, as the local model, a model in which processing to handle as a missing value is performed on a node corresponding to a device other than the own device, in a decision tree constituting the vertical federated learning model.

4. The learning device according to claim 3, wherein the at least one processor is configured to execute the instructions to
acquire, as the local model, a model in which processing to previously determine a branch direction at an object node is performed, as the processing to handle as a missing value.

5. The learning device according to claim 3, wherein the at least one processor is configured to execute the instructions to
in another learning device that is different from the own device, acquire a model in which the processing to handle as a missing value is performed on a node corresponding to a feature value held by the other learning device, from the other learning device as the local model.

6. The learning device according to claim 1, wherein the at least one processor is configured to execute the instructions to
learn an additional tree to be added to the local model by performing learning using the calculated difference as an objective variable and the feature value held by the own device as an explanatory variable.

7. The learning device according to claim 1, wherein the at least one processor is configured to execute the instructions to
acquire an output of the vertical federated learning model in cooperation with each client device that created the vertical federated learning model.

8. A learning method comprising, by an information processing device:
acquiring a local model corresponding to a feature value held by an own device;
calculating a difference between an output of a vertical federated learning model having been learned previously and an output of the acquired local model; and
learning an additional tree to be added to the acquired local model on a basis of a result of the calculation and the feature value held by the own device.

9. An inference device comprising:
at least one memory configured to store instructions; and
at least one processor configured to execute instructions to:
input a feature value that is an inference object to a local model to which an additional tree is added based on a result of calculating a difference between an output of a vertical federated learning model and an output of the local model and on the feature value held by the own device, the vertical federated learning model having been learned previously, the local model corresponding to a feature value held by an own device, and perform output corresponding to a result of the input.
